(19) United States
(12) Patent Application Publication
(10) Pub. No.: US 2010/0181963 A1
(43) Pub. Date: Jul. 22, 2010

(54) Battery Charger and Method for its Operation

(75) Inventor: Dejan SCHREIBER, Nuernberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: SEMIKRON Elektronik GmbH & Co. KG, Nurnberg (DE)

(21) Appl. No.: 12/689,908

(22) Filed: Jan. 19, 2010

(30) Foreign Application Priority Data
Jan. 20, 2009 (DE) 10 2009 000 328.2

(51) Int. Cl. H02J 7/00

(52) U.S. Cl. 320/108

(57) ABSTRACT

A battery charger having an RF storage transformer whose primary winding is connected via a clock to a two-pole input for receiving an AC voltage, and whose secondary winding is connected as a flyback converter to a rectifier with a two-pole output for the battery. The charger has a measurement unit, which detects the input current and voltage and a controller which operates the clock as a function thereof. A method for operating the charger, wherein the controller continually switches the clock on for a first interval and switches it off for a second interval, wherein the first interval ends when the current rises to a value corresponding to the instantaneous value of the voltage times a scaling factor, and the duration of the first and second intervals is sufficiently long that their total duration corresponds to the period of one interval of permissible operating frequencies of the transformer.

### BACKGROUND OF THE INVENTION

1. Field of the Invention

The invention relates to a battery charger and a method for its operation.

2. Description of the Related Art

Electrically-powered passenger vehicles operate on the principle of taking electrical energy for charging the vehicle drive battery from the power supply grid—or in other words “from the plug socket”. This requires a battery charger for charging the vehicle battery, often from the user's home. The normal power that can be drawn from a plug socket in a private household is about 3.5 kW, with protection by means of a 16 A fuse. The requirements for a battery charger are for it to draw a sinusoidal system current from the system (“grid”) voltage, and for the battery to be galvanically isolated from the grid by the charger, for example by an isolating transformer.

The basic design of such modern battery chargers is shown in FIG. 7. An input 4 of a known battery charger 300 is connected to a supply system 6, and its output 8 is connected to a battery 10. The grid voltage U_{N} in supply system 6 is, in this case, in the range 100-250 V at a frequency of 50-60 Hz. The battery voltage U_{B} of the battery 10 is, for example, in a wide voltage range between 250V and 450V, and is dependent on the battery state of charge.

In battery charger 300, input 4 is connected to a first rectifier 310 which feeds a PFC 312 (power factor corrector—step-up converter). PFC 312 contains an inductor 313 with an inductance L₁, a short-circuiting switch 315 and a freewheeling diode 317. PFC 312 charges an intermediate circuit capacitor 314 to a constant, regulated intermediate circuit voltage U_{Z} of, for example, 380V.

Intermediate circuit capacitor 314 is followed by an inverter 316 which is here in the form of an H bridge, is clocked at medium to high frequency and, at its output, produces a regulated, medium-frequency to high-frequency voltage U_{W}. Voltage U_{W} feeds the primary side or primary winding of an RF transformer 318 which can be made to be small and light. RF transformer 318 matches voltage U_{N} to the battery voltage U_{B} by transmission to its secondary side or secondary winding. At the same time, RF transformer 318 provides the galvanic isolation of battery 10 from supply system 6, and of the secondary side of the battery charger 300 from its primary side. The secondary side of the RF transformer 318 is followed by a second rectifier 20, which is connected via an inductor 322 with inductance L₂ to output 8.

In this case, battery voltage U_{B} is regulated by deliberate pulse processes, in particular pulse-width modulation (PWM), which are implemented in inverter 316.

Battery charger 300 therefore complies with the major requirements mentioned above, in particular with regard to drawing a sinusoidal current I_{N} from supply system 6 at input 4.

In order to avoid uncontrollable or excessive capacitor charging currents (for example an unacceptably high inrush current when battery charger 300 is switched on), it is known for rectifier 310 not to be in the form of a diode bridge, as in FIG. 7, but to be in the form of a controlled half bridge with thyristors.

Battery charger 300 is designed in accordance with the textbook concept, in which a total of four converters are connected in series, specifically rectifier 310, PFC 312, inverter 316 and rectifier 20. A multiplicity of semiconductor switches and passive components are used, overall. The energy flow direction is restricted to the direction from supply voltage 6 to battery 10, and it is not possible to feed energy back into the grid.

### SUMMARY OF THE INVENTION

The object of the invention is to provide an improved battery charger and method for its operation.

The battery charger preferably contains an RF storage transformer with a primary winding and a secondary winding. The primary winding is connected to a two-pole input via a clock switch. The clock switch is in this case a bidirectional switch, that is to say current can flow through it in both directions. During operation, the battery charger is supplied with AC voltage, for example from a supply voltage system (power grid). The secondary winding of the RF storage transformer is connected in the form of a flyback converter to the input of a rectifier, in particular a diode rectifier in the form of a flyback converter. The rectifier has a two-pole output, on its output side, to which the battery to be charged during operation can be connected. The battery charger also has a measurement unit which detects the instantaneous values of the current and voltage at the input—that is to say, when connected to a supply voltage system, its instantaneous supply system voltage and the corresponding instantaneous supply system current flowing into the battery charger.

Furthermore, the battery charger includes a controller which operates the clock switch as a function of the values of the current and voltage measured by the measurement unit, i.e., switches it “on” or “off”. Switching “off” in this case means that the current flow from the input to the primary winding is interrupted. The RF storage transformer provides galvanic isolation between a primary side, facing the input, and a secondary side of the battery charger, facing the output.

The invention is in this case based on the following knowledge and considerations: the known battery charger has an intermediate circuit capacitor which, from the point of the input, represents a load with an impressed voltage. Since the voltage system to be connected represents an impressed-voltage source, a first inductor must be used between the input and the intermediate circuit capacitor. For the same reasons, a further inductor must be used between the input circuit capacitor and the output, i.e., the battery.

Because of the galvanic isolation, the RF transformer must remain in the battery charger. However, this already has a primary winding and a secondary winding which must be designed to accommodate the maximum possible currents flowing from the voltage system and for the maximum battery charging currents. The windings of the RF transformer can now, according to the invention, also be used for provision of the abovementioned inductances or inductors. In other words, the windings of the transformer carry out a dual function, as inductors associated with the input and output as well as the voltage system and the battery, in addition to their actual purpose of transformer action.

The number of passive components is intended to be less than that in known battery chargers. If, for this purpose, the intermediate circuit capacitor is removed from the circuit, the charger according to the invention will be smaller and lighter, but will no longer have any capacitive energy storage capability. The power drawn from the voltage system must then be transferred directly to the battery without any capacitive intermediate storage.

Therefore, according to the invention, the input rectifier, step-up converter, intermediate circuit capacitor and inverter are replaced by a single unit. This is because the input voltage or the current from the supply system is transmitted directly via the clock switch to an inductance L₁ as an inductor in the form of the primary winding of the RF transformer. This transmits the energy to the inductor L₂, in the form of the secondary winding of the RF transformer. The inductances L₁ and L₂ are closely coupled in the form of the primary and secondary windings, and are wound on a magnet core with an air gap. In this way, they form the radio-frequency transformer and at the same time provide galvanic isolation between the primary and secondary sides.

The battery charger according to the invention is operated by the controller with a switching period of variable length with respect to its clock switch. Specifically, the clock switch has a first time interval, associated with the primary side, during which the clock switch is closed, or “on”. The clock switch is open, or “off” in a second time interval, associated with the secondary side. The electrical variables, specifically the respective currents on the primary and secondary sides of the battery charger, are regulated by the duration of the respective switching times.

First of all during operation, the controller determines the time profile of the system voltage. It uses any design of the scaling factor which must however be chosen to be fixed, to map the curve shape of the system voltage onto a limit curve, which is in phase with this, for current values. This limit curve may also be determined in other ways, for example by determining the zero crossings of the system voltage and of the sinusoidal pattern of a desired amplitude.

At the start of each first time interval, the clock switch is switched on and the current which is actually flowing into the battery charger and rises gradually because the primary winding acts as an inductor, is measured. When the system current reaches a limit value which corresponds to the instantaneous value of the limit curve, the clock switch is opened. The first time interval ends, and the second starts.

Because of the flyback converter functionality, current does not start to flow through the secondary winding, with the energy stored in the transformer flowing to the battery, until this point in time. The current which was previously flowing in the primary winding is therefore transmitted in the RF transformer to the secondary winding, which means that the energy is passed to the battery. The second time interval is chosen such that the switching period, that is to say the sum of the first and second time intervals, corresponds to a maximum permissible operating frequency of the RF transformer. The duration of successive switching periods may in this case always vary since, in particular, the rise in the current up to the limit value in the first time interval lasts for different times.

In other words, the energy brought from the source and stored in the inductance on the primary side is transmitted in the first part of the switching period. Energy is transferred from the inductance of the secondary side to the load in the second part of the switching period. The energy is interchanged and/or split internally in the RF transformer between the inductance on the primary side and that on the secondary side.

Two alternatives are possible: in the first alternative, all of the energy which is stored in the RF transformer or has been fed into it in the first part of the switching period is transferred to the battery in the second part of the switching period. The RF transformer is then charged with energy once again in a subsequent first part of the switching period. In the second alternative, only a portion of the stored energy is transferred to the battery in the second part of the switching period. Further energy is then fed additively into the RF transformer in the subsequent first part of the switching period.

The inventive battery charger therefore meets with the requirements mentioned above, but requires fewer circuit components to do so. In particular, the number of passive components in the battery charger according to the invention is considerably reduced. The intermediate circuit capacitor which must be designed for the converter power in the prior art is not required, since the system power is transferred directly to the battery without intermediate storage. The system voltage is linked directly to the inductance L₁ via the bidirectional switch. The outputs of a plurality of battery chargers according to the invention can be operated in parallel on a battery to be charged, in which case each charger feeds as much power into the battery as this respective battery charger can supply.

The inductances L₁ and L₂ are closely coupled to one another and are wound on a single magnet core such that they together form an RF transformer for galvanic isolation of the primary side and secondary side. The RF transformer is also at the same time an inductor for the primary side and secondary side. With regard to the RF transformer, the product of the system voltage and the time per primary winding is equal to the product of the output voltage and time T₂ per secondary winding. With the input voltage u₁(t) for the primary winding, the output voltage from the secondary winding u₂(t), the first time interval from T₀ to T₁ and the second time interval from T₁ to T₂ and the number of windings N₁ on the primary side and N₂ on the secondary side, then:

$$\frac{1}{{N}_{1}} {\int }_{{T}_{0}}^{{T}_{1}} {u}_{1} ( t ) d t = \frac{1}{{N}_{2}} {\int }_{{T}_{1}}^{{T}_{2}} {u}_{2} ( t ) d t .$$

In other words, the sum of the volt-seconds per winding in the RF storage capacitor per switching period is equal to zero. The battery charger is suitable for two-quadrant operation, that is to say for a power flow from the input to the output, i.e., from the supply voltage system to the battery.

In one advantageous embodiment of the invention, a freewheeling branch is connected to and associated with the primary winding of the RF storage transformer. The freewheeling branch contains a freewheeling switch, which can be operated by the controller. The freewheeling branch can be closed or opened by means of the freewheeling switch. When it is open, the freewheeling branch has no effect whatsoever in the battery charger. When the freewheeling switch is closed, the energy which has already been drawn from the voltage system and is stored in the RF transformer can remain there, and the current flowing in its primary winding can continue to flow, after the clock switch has been opened. The energy need not be passed onto the battery. This is useful when, for example, the battery is fully charged but the battery charger is still in operation.

In a further preferred embodiment, a corresponding freewheeling branch is alternatively or additionally connected to the secondary winding of the RF storage transformer. A current that is flowing then continues to flow through the secondary winding. The energy is therefore likewise held in the RF transformer.

In a further advantageous embodiment, the freewheeling branch for the secondary winding of the RF storage transformer can also be integrated in the rectifier which is arranged on the secondary side. A rectifier always has a topology which connects the two ends of the secondary winding. The freewheeling branch can thus be provided without a high degree of complexity by installation of suitable switchable components.

This can be accomplished particularly easily if the rectifier is a diode rectifier and at least two of the branches of the rectifier each form a freewheeling branch with a short-circuiting freewheeling switch operated by the controller.

At least two of the diodes are therefore associated with a freewheeling branch. A parallel-connected bypass branch, which can be short-circuited, can then be added to the diodes and also allows current to flow in the reverse direction of the diodes. One component which has an appropriate response, including the diode response, is an IGBT. At least two diodes in the diode rectifier are therefore each replaced by an IGBT in a particularly advantageous embodiment. In this case, therefore, the bypass branch always contains a short-circuiting bypass switch which can be operated by the controller. The diode rectifier in a modified form therefore carries out both tasks, specifically rectification of the transformed current, and the freewheeling characteristic when required.

If all of the diodes in the diode rectifier each have a short-circuiting bypass switch—to be precise the appropriate refinement as mentioned above—this results in an inverter. In other words, the rectifier is then replaced by an inverter which can alternatively be operated as such. Energy or current emitted from the battery can then be inverted by the inverter and transferred back to the RF storage transformer. The primary side of the battery charger is in any case already suitable for four-quadrant operation, as a result of which the entire circuit is suitable for four-quadrant operation. Energy can thus be fed back from the battery into the voltage system, as well. This is of interest for utility companies which could use a large number of electrically powered passenger vehicles connected to the supply system as a collective energy store.

On the other hand, it would also be possible to collectively feed energy produced in individual passenger vehicles, for example by means of a solar panel or in some other way into the power system.

In a further advantageous embodiment, the battery charger also contains an isolating switch, which isolates the output from the input and can likewise be operated by the controller. The isolating switch can in this case, for example, isolate the output from the rest of the battery charger. An appropriate isolating switch allows the battery to be isolated from the battery charger, or from at least a part of it, with the input, and therefore from the supply system.

In this case, as well, in one particularly preferred embodiment, the isolating switch is integrated in the rectifier since this is the battery charger component that is closest to the output. For example, in the case of a diode rectifier, two branches can each be interrupted. For example, two IGBTs connected back-to-back in series can be provided in the respective branch.

With regard to the method, the object of the invention is achieved by a method for operation of a battery charger as already described above—together with the advantages described. The controller in this battery charger therefore switches the clock switch “on” and “off” continually. It is switched “on” during a first time interval, with the first time interval ending when the current has risen to a limit value. This limit value is the instantaneous value of the measured voltage multiplied by a scaling factor. The second time interval is then chosen such that the total duration of the first and second time intervals corresponds to the period duration of one interval of permissible operating frequencies of the RF storage transformer. In other words: the RF transformer is generally permissible not only for a single operating frequency but for a range of operating frequencies, for example between 16 kHz and 25 kHz. This range is associated with a range of associated period durations. The first and the second time intervals are therefore chosen such that their sum results in a period duration which is in the above-mentioned permissible range.

In other words, the choice of the first time interval means that the envelope of the current results in a curve which simply scales the time profile of the voltage, i.e., it is in phase with it. This means that a current which is uniform except for any residual ripple voltage, e.g., a sinusoidal current, is drawn at the input of the voltage system and the power factor of the battery charger is unity.

In a further preferred embodiment, the scaling factor is determined—for example by the controller—from the maximum value of the voltage and a maximum nominal current level of the input. A limit curve is therefore defined for the current flowing at the input, which limit curve has the maximum nominal current as a maximum and which can therefore never exceed the actually flowing current. In contrast to a maximum current limit which provides a cut-off, the power system currents of the battery charger therefore are always sinusoidal, since they are scaled down by the limit curve as an entity.

In a further preferred embodiment, the primary or the secondary side of the RF transformer is operated in a freewheeling mode for a third time interval within the first and/or second time interval. By way of example, the abovementioned freewheeling branches are suitable for this purpose. This results in the options mentioned above for storing the energy already drawn from the system—or from the battery when the energy flow is in the opposite direction—in the RF storage transformer, to be precise in its windings which act as an inductor, without this having to be passed to the battery or to the supply system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

For a further description of the invention, reference is made to the exemplary embodiments in the drawings which, in each case, are in the form of a schematic outline sketch:

FIG. 1 shows the inventive battery charger;

FIG. 2 shows embodiments of the a) clock switch and b) the rectifier from the charger of FIG. 1;

FIG. 3 shows the time profile of various electrical variables from FIG. 1 from a) partial and b) complete energy transmission between the transformer and battery;

FIG. 4 shows the time profile of further electrical variables from FIG. 1;

FIG. 5 shows an alternative battery charger having various freewheeling branches on the secondary and primary sides;

FIG. 6 shows an alternative battery charger with an isolating switch for the output; and

FIG. 7 shows a battery charger according to the prior art.

### DETAILED DESCRIPTION OF THE PRESENTLY PREFERRED EMBODIMENTS

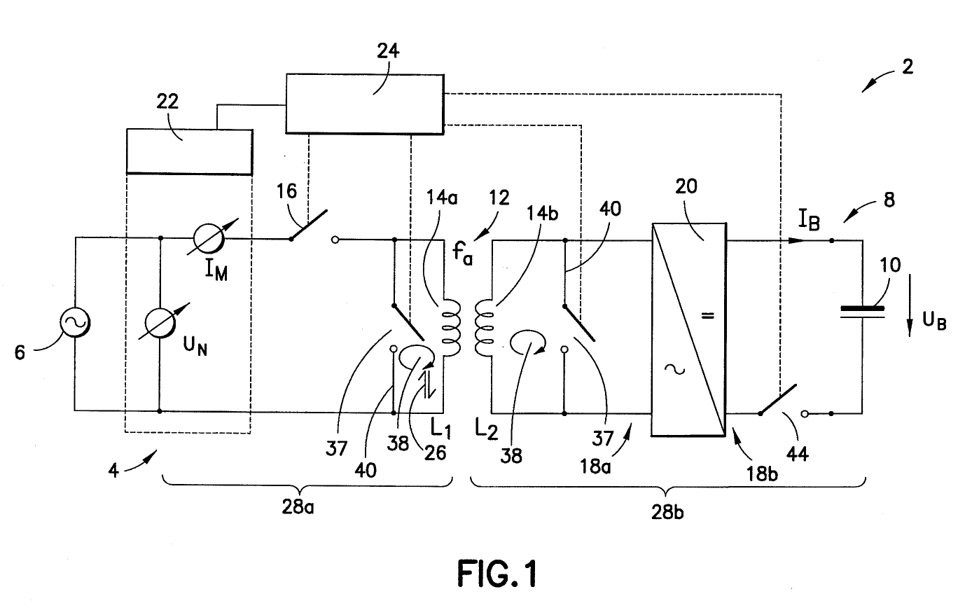

FIG. 1 shows a battery charger 2 in accordance with the invention. Battery charger 2 has an input 4, via which it is connected to a supply voltage system 6 (e.g., the power grid) with a system voltage of U_{N}=230V, and having an output 8 to which a battery 10 with a battery voltage U_{B} is connected for charging. Battery charger 2 includes an RF isolating transformer 12, whose primary winding 14a has an inductance L₁ and is connected to input 4 via a switch 16. The secondary winding 14b has an inductance L₂, and is connected to the input 18a of a rectifier 20. Output 18b of rectifier 20 is connected to output 8, at which the battery voltage U_{B} is present.

Battery charger 2 further includes a measurement unit 22, which detects the system voltage U_{N} applied to input 4, as well as system current I_{N} flowing into battery charger 2 at input 4. Measurement unit 22 is connected to a controller 24, which operates switch 16. Switch 16 is a bidirectional switch, i.e., when it is closed, it can pass both positive and negative currents I_{N}, as indicated by arrows 26. Windings 14a and 14b in transformer 12 are wound on a common magnet core, which is not illustrated but has an air gap, and inductances L₁ and L₂ are therefore closely coupled to one another. RF transformer 12 represents the galvanic isolation between primary side 28a and the secondary side 28b of the battery charger 2. RF transformer 12 is an RF storage transformer, and is connected to rectifier 20 in the form of a flyback converter. In RF transformer 12, current can therefore flow only in primary winding 14a or in secondary winding 14b.

FIG. 1 also shows an alternative refinement of primary side 28a and/or primary side 28b: A freewheeling branch 40 or a freewheeling network 38 which can be switched on by controller 24 can be short-circuited via primary winding 14a or secondary winding 14b, respectively. Energy stored in the relevant windings can then be stored in the primary or secondary windings by closing freewheeling branch 40, without this energy having to be emitted back to the supply system 6 or to the respective other winding or battery 10.

A further alternative embodiment of the battery charger contains an isolating switch 44 which can be switched by controller 24 and, in the example, is arranged downstream from rectifier 20. This is used to disconnect battery 10 and can also be arranged at some other suitable point in the circuit of secondary side 28b.

In one alternative embodiment, which is not illustrated, a plurality of apparatus or parts thereof according to the invention—at least RF transformers 12 with respectively associated clock switches 16—are connected in parallel between a single supply system 6 and a single battery 10.

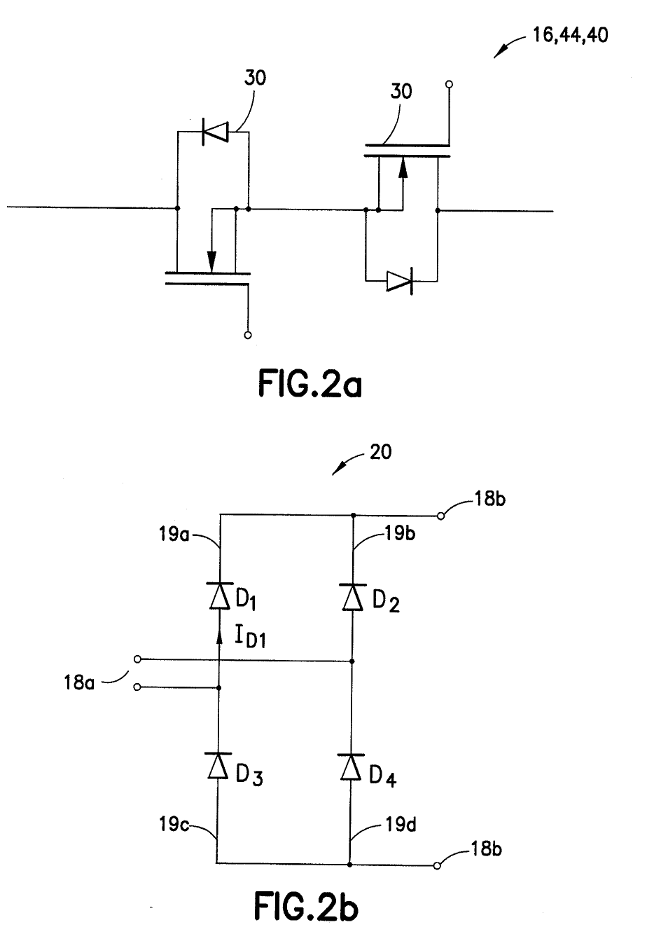

FIG. 2a shows one specific embodiment of a switch 16 which can be used as isolating as a switch 44 or switch for the freewheeling branch 40, and which can be switched bidirectionally, that is to say two RBIGBTs 30 connected in series.

FIG. 2b shows a refinement of the rectifier 20 as a diode rectifier with diodes D₁₋₄ each in a respective branch element 19a-d. During operation, a corresponding current, for example I_{D1}, flows through each diode.

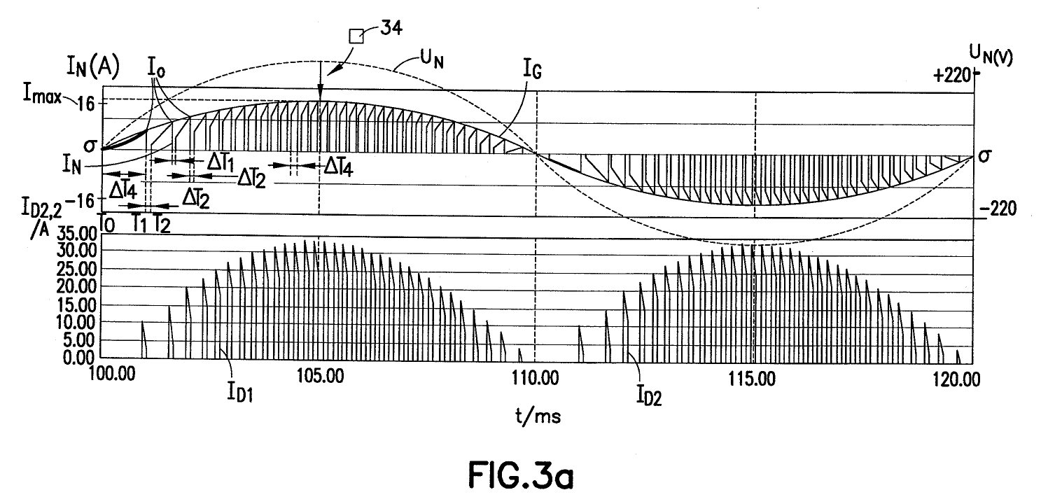

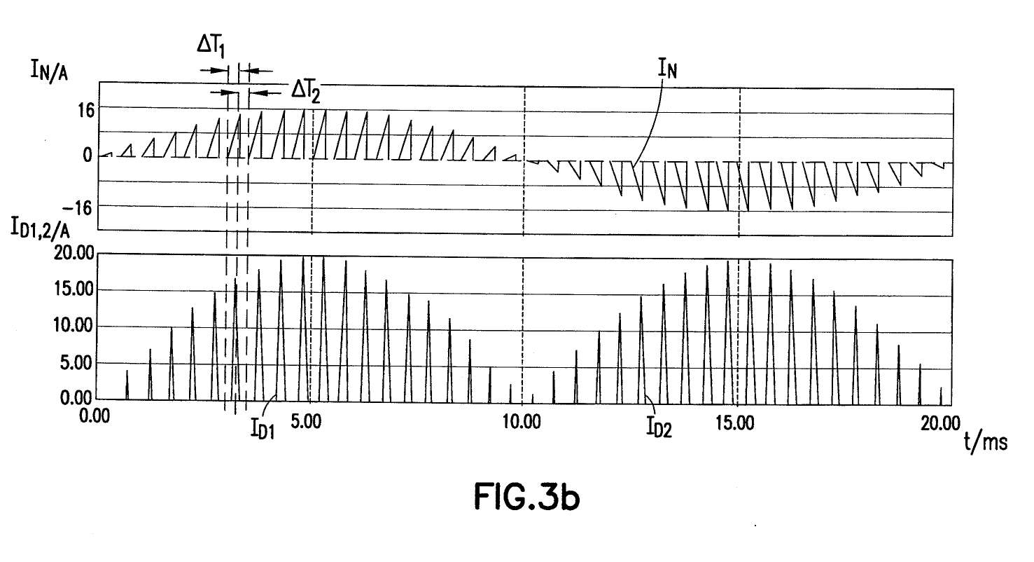

FIG. 3a shows various electrical variables during operation of the battery charger 2, plotted against the time t/ms. The figure shows one complete oscillation period of 20 ms of the 50 Hz mains voltage U_{N}, which oscillates sinusoidally between −220V and +220V. Measurement unit 22 detects the time profile of this voltage and transmits this to controller 24 which scales the time profile of the system voltage U_{N} with the aid of a scaling factor 34, to a sinusoidal curve of a limit current I_{G}. In this case, the scaling factor 34 is defined such that the maximum value Iₘₐₓ of the limit current I_{G} is in each case ±16A.

At the time T₀, controller 24 now starts to close switch 16 and, with the aid of measurement unit 22, follows the profile of the current level I_{N}. As soon as current level I_{N} reaches the value of limit current I_{G}, which is the case at the time T₁, after a time interval ΔT₁=T₁−T₀, controller 24 switches switch 16 on again. The instantaneous value of limit current I_{G} therefore in this case forms the limit value I₀ for current I_{N}. Controller 24 then keeps switch 16 closed until time T₂. In the present example, the length of the time interval T₂−T₁ is chosen to be constant. At the time T₂, after the time interval ΔT₂=T₂−T₁, switch 16 is closed again, and controller 24 once again observes when system current I_{N} is equal to limit current I_{G}, in response to which controller 24 once again opens switch 16 after a renewed interval ΔT₁. This time interval ΔT₁ is in general not equal to the previous time interval ΔT₁. Switch 16 then once again remains closed for time interval ΔT₂ although ΔT₂ is always of the same duration.

The interval ΔT₁ in which switch 16 remains open is therefore dependent on when the system current I_{N} reaches the limit current I_{G}, and is therefore variable. The sum of in each case two successive intervals ΔT₁ and ΔT₂ represents the switching period of clock switch 16, which represents the period duration of the operating frequency of RF transformer 12. As can be seen from FIG. 3a, RF transformer 12 is operated continuously at different operating frequencies on its own during one half-cycle of system voltage U_{N}.

Time interval ΔT₂ is chosen such that the resultant operating frequencies are in the permissible range of RF transformer 12. Currents I_{D1} through the diode D₁, which are likewise illustrated in FIG. 3a, result for the first, positive half-cycle of the system voltage U_{N}, as shown in FIG. 3a. These currents each flow during the time intervals ΔT₂, i.e., when switch 16 is open. Battery 10 is charged by the correspondingly produced current pulses of current I_{D1}, since the diode current in this case directly forms battery current I_{B}. In the second half-cycle in FIG. 3a, the current directions in the circuit of FIG. 1 are reversed, as a result of which the current I_{D2} now flows through diode D₂.

During the first respective time interval ΔT₁, the power is therefore drawn from supply system 6 and is stored in primary winding 14a, and the correspondingly stored power is transferred during time interval ΔT₁ (via the magnet core that is not illustrated, or its air gap) via winding 14b to battery 10. In the example, time ΔT₂ is constant, and is preferably approximately 100 μs.

As can also be seen, the power factor between system voltage U_{N} and system current I_{N} or its envelope is cos φ=1, or λ=1. The envelope coincides with limit current I_{G}.

In FIG. 3a, the energy is not all drawn from RF transformer 12 in the respective time intervals ΔT₂; only a partial energy transfer takes place. The current curves I_{D1,2} therefore do not fall to zero at the end of the respective interval, but are cut off. Therefore, in the time intervals ΔT₁, the current flow into primary winding 14a also does not start at zero, but cuts in at a higher current level.

In contrast, FIG. 3b shows a situation in which RF transformer 12 is completely discharged to battery 10 in each time interval ΔT₂. The current curve I_{D1,2} falls to zero in each time interval ΔT₂. The charging curve of current I_{N} therefore also starts at zero in each interval ΔT₁.

When RF transformers 12 with clock switches 16 are connected in parallel as mentioned above, a further advantageous control method is possible: When N transformers are connected in parallel, the individual clock switches 16 are operated with a phase offset of, for example, 360°/N. At the battery, this leads to the battery current I_{B} having a current curve which is considerably smoother than that in FIGS. 3a, b, since the currents produced by the individual RF transformers are superimposed with a corresponding phase offset.

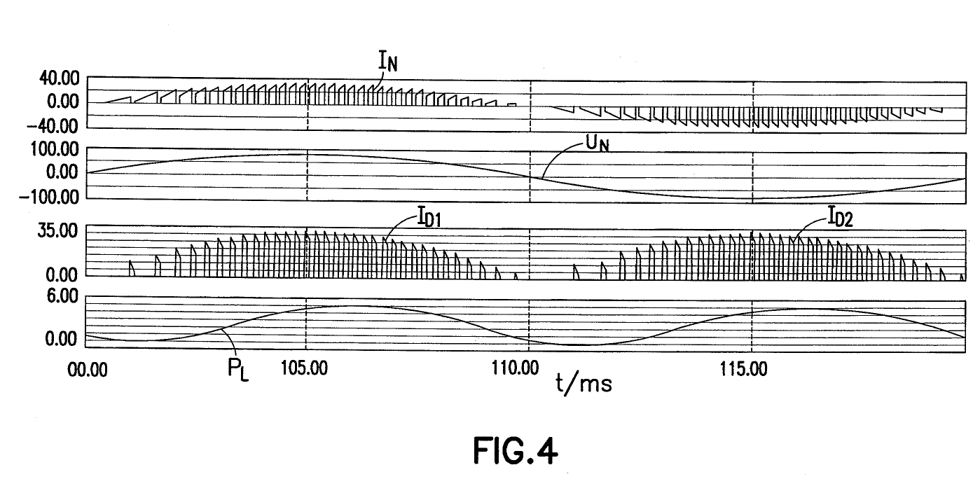

FIG. 4 once again shows the charging current I_{D1} and I_{D2} from FIG. 3, together with the charging power P_{L} of the battery. The battery charging power corresponds to the current I_{D1} or I_{D2} multiplied by the battery voltage U_{B}, or approximately to the output voltage of secondary winding 14b, and is pulsed at twice the system frequency. The peak power value is equal to twice the mean value.

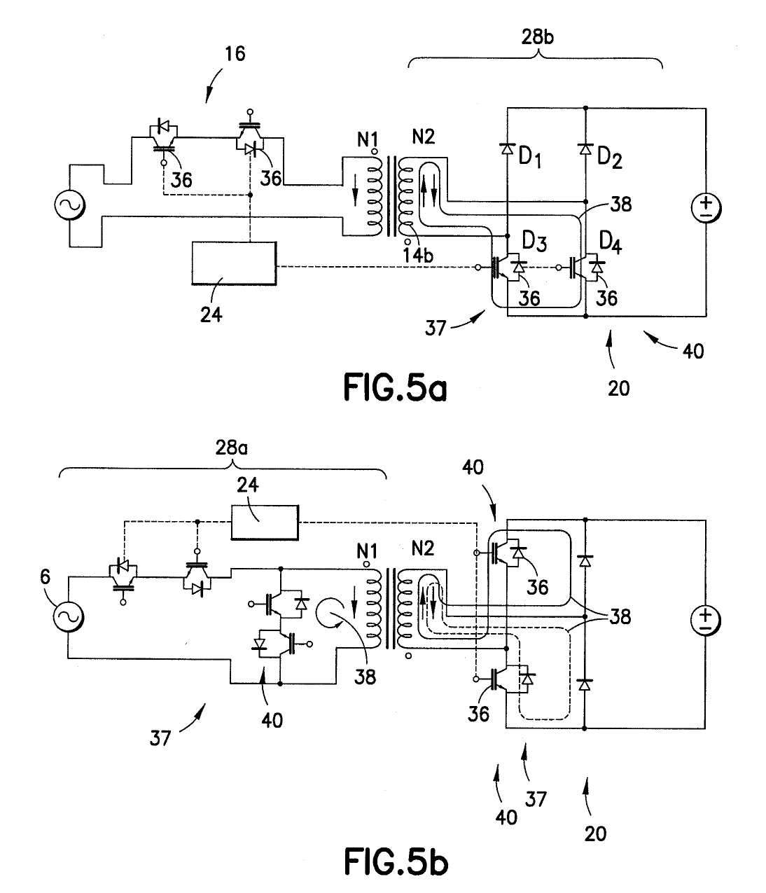

FIGS. 5a, b show embodiments in which, in contrast to FIG. 2, switch 16 is provided by two series-connected IGBTs 36. However, particularly on secondary side 14b, diodes D₃ and D₄ in rectifier 20 are each replaced by an IGBT 36. In other words, IGBT 36 integrates diode D₃ together with a bypass switch which can be switched on and therefore forms a freewheeling switch 37, thus making it possible to deliberately cancel out the blocking effect of the diode D₃. That branch of rectifier 20 which contains the diode D₃ therefore forms a freewheeling branch 40. For secondary winding 14b, this therefore results in freewheeling network 38 or freewheeling branch formed by the diodes and the correspondingly switched-on IGBTs 36 at the location of the diodes D₃ and D₄. During the clock period ΔT₂, the energy stored in the winding 14b which acts as an inductor can therefore be maintained, in that its current flows through freewheeling network 38.

FIG. 5b shows an alternative refinement of a rectifier 20 in which the diodes D₁ and D₃ are replaced by IGBTs 36. This results in two different freewheeling networks 38 for different current directions for winding 14b.

In all cases, IGBTs 36 are operated in a corresponding manner centrally by controller 24, in order to switch on freewheeling networks 38 at a suitable point in time. A correspondingly specifically designed freewheeling branch 40 and freewheeling switch 37 can be seen on primary side 28a.

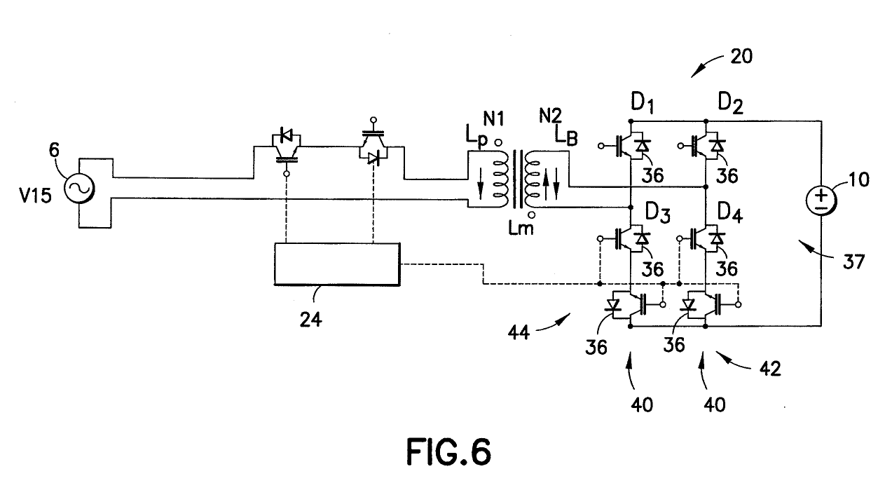

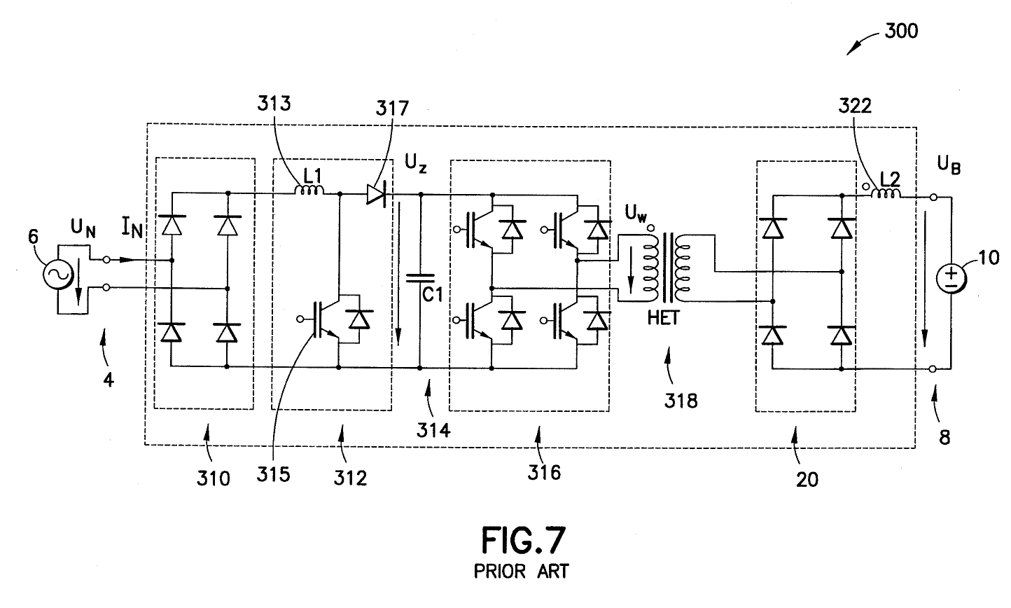

FIG. 6 shows a further embodiment of a battery charger 2, in which blocking IGBTs 36 are also connected in rectifier 20 in series with the IGBTs 36, in place of diodes D₃ and D₄, in order to completely isolate battery 10 from battery charger 2, as a result of which no current whatsoever can flow in this case. The lower half of rectifier 20 in FIG. 6 can thus be blocked completely. The two IGBTs 36 in the branch of diode D₃ therefore in this case act as an isolating switch 44. The lower IGBTs 36 are each switched on for rectifier operations.

In FIG. 6, diodes D₁ and D₂ are also replaced by IGBTs 35. This allows rectifier 20 to be operated as an inverter 42. Energy can therefore be transported from battery 10 to supply system 6.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A battery charger for charging a battery, the battery charger having a two-pole input for receiving a current (I_{N}) and an AC voltage (U_{N}), the battery charger comprising:
a rectifier which has a two-pole output for connecting to the battery;
an RF storage transformer having a primary winding connected via a clock switch to the input of the battery charger, and a secondary winding connected in the form of a flyback converter to said rectifier;
a measurement unit, which detects the current (I_{N}) and the voltage (U_{N}) at the input of the battery charger; and
a controller which operates said clock switch as a function of the current (I_{N}) and the voltage (U_{N}) at the input of the battery charger.

2. The battery charger of claim 1, further comprising:
a first freewheeling branch associated with said primary winding of said RF storage transformer; and
a first short-circuiting freewheeling switch in said first freewheeling branch, operated by said controller.

3. The battery charger of claim 2, further comprising:
a second freewheeling branch associated with said secondary winding of said RF storage transformer; and
a second short-circuiting freewheeling switch in said second freewheeling branch, operated by said controller.

4. The battery charger of claim 3, wherein at least one of said first and second freewheeling branches is integrated in said rectifier.

5. The battery charger of claim 4, wherein said rectifier is a diode rectifier having branch elements, and at least two of said branch elements of said rectifier each form one of said first and second freewheeling branches said respective short-circuiting freewheeling switch.

6. The battery charger of claim 1, further comprising:
a freewheeling branch associated with said secondary winding of said RF storage transformer; and
a short-circuiting freewheeling switch which is operated by said controller.

7. The battery charger of claim 6, wherein said freewheeling branch is integrated in said rectifier.

8. The battery charger of claim 7, wherein said rectifier is a diode rectifier having branch elements, and at least two of said branch elements of said rectifier each form said freewheeling branch with a short-circuiting freewheeling switch which is operated by said controller.

9. The battery charger of claim 1, further comprising an isolating switch which is operated by said controller for isolating the output of the battery charger from the input thereof.

10. The battery charger of claim 9, wherein said isolating switch is contained in said rectifier.

11. A method for operating a battery charger having a two-pole input for receiving an AC voltage, and comprising:
a rectifier which has a two-pole output for connecting to the battery;
an RF storage transformer having a primary winding connected via a clock switch to the input of the battery charger, and a secondary winding connected in the form of a flyback converter to said rectifier;
a measurement unit, which detects current (I_{N}) and voltage (U_{N}) at the input of the battery charger; and
a controller which operates said clock switch as a function of current (I_{N}) and voltage (U_{N});
the method comprising the steps of:
continually switching said clock switch “on” for a first time interval (ΔT₁) and “off” for a second time interval (ΔT₂), wherein said first time interval (ΔT₁) ends when the input current (I_{N}) has risen to a predetermined limit value (I₀) which corresponds to the instantaneous value of the voltage (U_{N}) multiplied by a predetermined scaling factor, and wherein said second time interval (ΔT₂) is chosen to be sufficiently long that the total duration of said first time interval (ΔT₁) and said second time interval (ΔT₂) corresponds to the period duration of one interval of permissible operating frequencies (fₐ) of said RF storage transformer.

12. The method of claim 11, wherein said scaling factor is a function of the maximum value of the voltage (U_{N}) and a maximum nominal current level (Iₘₐₓ) flowing at the input of the battery charger.

13. The method of claim 12, wherein at least one of said primary winding and said secondary winding is operated in the freewheeling mode with a freewheeling branch for a third time interval (ΔT₃) within at least one said first time interval (ΔT₁) and said second time interval (ΔT₂).

14. The method of claim 11, wherein at least one of said primary winding and said secondary winding is operated in the freewheeling mode with a freewheeling branch for a third time interval (ΔT₃) within at least one said first time interval (ΔT₁) and said second time interval (ΔT₂).
